(19) United States
(12) Patent Application Publication
(10) Pub. No.: US 2020/0180217 A1
(43) Pub. Date: Jun. 11, 2020

(54) ENHANCED LAYER ADHESION IN ADDITIVE MANUFACTURING BY USE OF MULTIPLE HEATING STEPS

(71) Applicant: SABIC GLOBAL TECHNOLOGIES B.V., Bergen op Zoom (NL)

(72) Inventors: Elena MILOSKOVSKA, Breda (NL); Bruke JOFORE, Bergen op Zoom (NL); Hao GU, Bergen op Zoom (NL); Raul FERNANDEZ CABELLO, Bergen op Zoom (NL); Vandita PAI-PARANJAPE, Evansville, IN (US); Federico CACCAVALE, Hoogerheide (NL); Brian PRICE, Evansville, IN (US)

(21) Appl. No.: 16/608,274

(22) PCT Filed: Apr. 26, 2018
(86) PCT No.: PCT/US2018/029512

§ 371 Date: Oct. 25, 2019

Related U.S. Application Data
(60) Provisional application No. 62/490,170, filed on Apr. 26, 2017.

(51) Int. Cl. B29C 64/153; B33Y 10/00; B33Y 30/00; B29C 64/118; B29C 64/268

(52) U.S. Cl. CPC B29C 64/153; B33Y 10/00; B29C 64/393; B29C 64/118; B29C 64/268; B33Y 30/00

(57) ABSTRACT

Provided are systems and methods for additive manufacturing, which systems and methods yield parts having improved interlayer adhesion. In the disclosed technology, additional heating steps are applied on the upper surface of the already printed workpiece so as to offset the dropping temperature of that surface during part fabrication. These heating steps elevate the temperature of the surface to a value that results in a molten interface with subsequently-applied build material, leading to improved interlayer adhesion. This technology is applicable to a variety of additive manufacturing processes, including but not limited to selective laser sintering, fused filament fabrication, and large format additive manufacturing approaches.

### TECHNICAL FIELD

The present disclosure relates to the field of additive manufacturing and to polymeric materials.

### BACKGROUND

Additive manufacturing techniques use a layer-based approach to manufacture complex 3D-objects. One of the common techniques used for polymeric powder materials, known as selective laser sintering (SLS), has attained popularity in the market but nonetheless has certain drawbacks.

SLS typically uses a CO₂ or other laser to trace out and selectively sinter a predefined layer of the powder. In this technique a layer of material is scanned by the laser, the next layer of material is added and the process is repeated until all the layers are built to make the entire part. An issue with this technique, however, is suboptimal adhesion between layers, as such suboptimal adhesion creates printed parts with insufficient strength in the z-direction.

These and other shortcomings are addressed by aspects of the present disclosure.

### SUMMARY

The present disclosure provides, inter alia, methods that improve the interlayer adhesion and the mechanical performance of 3D printed parts in the z-direction. The disclosed methods include various features, including introduction of a heating step as extra step after the sintering of a layer as well as, in some aspects, adjusting the position of the spreader that transports powder within the printing system.

In one aspect, the present disclosure provides additive manufacturing systems, comprising: a substrate having an upper surface; a build platform having an upper surface; the build platform being moveable relative to the substrate so as to alter a distance between the upper surface of the substrate and the upper surface of the build platform; (a) a spreader configured to transfer a quantity of particulate from at least a first loading position on the upper surface of the substrate to a first pre-build position on the upper surface of the substrate, the spreader further being configured to transfer a quantity of particulate from the first pre-build position to the build platform, or (b) a dispenser configured to dispense an amount of molten filament to the upper surface of the substrate; a first build platform energy source configured to heat material disposed atop the build platform, a first pre-build energy source configured to effect a temperature at the first pre-build position that is higher than the temperature first loading position.

Aspects of the disclosure further relate to a method, comprising: transporting a first amount of feed polymer at a temperature T_{feed} from a first loading position and depositing at least a portion of the first amount of feed polymer on a workpiece; increasing the temperature of the portion of the first amount of feed polymer deposited on the workpiece to a temperature T_{bed}, which temperature is greater than T_{feed}; heating the portion of the first amount of feed polymer deposited on the workpiece to a temperature which temperature is greater than T_{bed}; transporting a second amount of feed polymer at a temperature T_{feed} from a second loading position to a first pre-build position; heating an upper surface of the workpiece to temperature Ti; depositing at least a portion of the second amount of feed polymer onto the upper surface of the workpiece; and heating at least the portion of the second amount of feed polymer t_{I}. The heating is effected so as form a pattern of fused polymer and to effect coalescence between the portion of the second amount of feed polymer and the upper surface of the workpiece, such that the portion of the second amount of feed polymer becomes the upper surface of the workpiece.

Further provided are additive manufacturing systems, comprising: a dispenser configured to dispense an amount of molten polymer filament onto a polymer workpiece; a build platform adapted to support a workpiece, one or both of the dispenser and build platform being capable of motion relative to the other; and an energy source configured to heat an upper surface of a workpiece disposed on the build platform.

### BRIEF DESCRIPTION OF THE DRAWINGS

The summary, as well as the following detailed description, is further understood when read in conjunction with the appended drawings. For the purpose of illustrating the technology, there are shown in the drawings exemplary and preferred aspects of the invention; however, the disclosure is not limited to the specific methods, compositions, and devices disclosed. In addition, the drawings are not necessarily drawn to scale. In the drawings:

FIG. 1A provides a schematic of an illustrative, standard additive manufacturing system;

FIG. 1B provides a schematic of standard roller movements for depositing a powder layer in a standard additive manufacturing system;

FIG. 2A provides a schematic illustration of the temperatures experienced during a single cycle in a standard SLS process;

FIG. 2B provides a schematic illustration of the temperatures experienced during a single cycle in an additive manufacturing process according to the present disclosure;

FIG. 3 provides a representation of an exemplary additive manufacturing system according to the present disclosure;

FIG. 4 provides a representation of forming structures in consecutive layers of polymer (e.g., particulate) material, according to the present disclosure;

FIG. 5 provides a representative temperature profile for a workpiece processed according to the present disclosure in which a second laser is used to maintain the printed part at a temperature that keeps it in a molten state;

FIG. 6 provides an alternative representation of forming structures in consecutive layers of polymer material, according to the present disclosure; and

FIG. 7 provides an application of the disclosed technology to an exemplary fused filament fabrication (FFF) system.

### DETAILED DESCRIPTION OF ILLUSTRATIVE EMBODIMENTS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps. It is to be understood that the terminology used herein is for the purpose of describing particular aspects only and is not intended to be limiting. Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams (g) to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

Weight percentages should be understood as not exceeding a combined weight percent value of 100 wt. %. Where a standard is mentioned and no date is associated with that standard, it should be understood that the standard is the most recent standard in effect on the date of the present filing.

Exemplary Aspects

The following aspects are exemplary only and do not serve to limit the scope of the present disclosure or the appended claims.

Aspect 1. An additive manufacturing system, comprising:

a substrate having an upper surface; a build platform having an upper surface;

the build platform being moveable relative to the substrate so as to alter a distance between the upper surface of the substrate and the upper surface of the build platform;

(a) a spreader configured to transfer a quantity of polymer (e.g., powder) from at least a first loading position on the upper surface of the substrate to a first pre-build position on the upper surface of the substrate, the spreader further being configured to transfer a quantity of polymer from the first pre-build position to the build platform, or

(b) a dispenser configured to dispense an amount of molten filament or pellets to the upper surface of a workpiece disposed on the build platform;

a first build platform energy source configured to heat material disposed atop the build platform; and,

a first pre-build energy source configured to effect a temperature at the first pre-build position that is higher than the temperature first loading position.

Suitable substrates may be, e.g., polymeric, ceramic, metallic, glass, and the like. A build platform may be, e.g., a stage disposed within the substrate, the stage being vertically moveable in the z-direction.

Aspect 2. The additive manufacturing system of aspect 1, further comprising a container configured to dispense a polymer proximate to the first loading position. Suitable containers include hoppers, funnels, buckets, baskets, and the like. A system may also be configured to dispense polymer (e.g., particulate) from below the substrate (e.g., in a well) to the substrate. In some aspects, polymer particulate may be stored on a moveable platform that moves vertically so as to place polymer particulate above the substrate, thereby making the polymer available for a spreader (e.g., a roller) to transport to another position.

Aspect 3. The additive manufacturing system of any of aspects 1-2, wherein one or more of the first build platform energy source and the first pre-build energy source comprises a laser, e.g., a CO₂ laser.

Aspect 4. The additive manufacturing system of any of aspects 1-3, wherein one or more of the first build platform energy source and the first pre-build energy source comprises an infrared source. Suitable infrared sources are known to those of skill in the art.

In one especially suitable aspect, a system may include one or more sources of infrared radiation configured to heat polymer disposed at one or more pre-build positions. The one or more sources of infrared radiation may include one or more lasers configured to heat the upper surface of a workpiece disposed on the system's build platform, as well as one or more lasers to effect sintering of polymer disposed atop the upper surface of the build platform.

In some aspects, a single laser may heat the upper surface of a workpiece disposed on the system's build platform as well as effect sintering of polymer (e.g., particulate) disposed atop the upper surface of the build platform.

Aspect 5. The additive manufacturing system of any of aspects 1-4, wherein the first build platform energy source and the first pre-build energy source are the same energy source (such as a single laser). It should be understood that this is not a requirement, as a system might comprise one energy source (e.g., a first laser) configured to effect heating of material atop the build platform, and another energy source (e.g., a second laser) that is configured to effect heating of material located at a pre-build position.

Aspect 6. The additive manufacturing system of any of aspects 1-5, wherein the spreader is characterized as a roller.

Aspect 7. The additive manufacturing system of any of aspects 1-5, wherein the spreader is characterized as being a blade.

Aspect 8. The additive manufacturing system of any of aspects 1-7, wherein the spreader is moveable to a second loading position and optionally moveable to a second pre-build position. Without being bound to any particular theory, a system may thus be configured such that the powder spreader may move in a reciprocating or back-and-forth manner between loading and pre-build positions, as well as to the build platform.

Aspect 9. The additive manufacturing system of aspect 8, wherein the spreader is moveable between the second pre-build position and the build platform.

Aspect 10. The additive manufacturing system of any of aspects 8-9, wherein the second loading position is disposed opposite the build platform relative to the first loading position. As described elsewhere herein, such an arrangement allows for reciprocating or back-and-forth motion of the powder spreader, which in turns allows for efficient operation of the system.

Aspect 11. The additive manufacturing system of any of aspects 1-10, further comprising one or more controllers configured to maintain a temperature at one or more of the build platform, the first loading position, the first pre-build position, the second loading position if present, and the second pre-build position if present.

As but one example, a controller may be configured to maintain powder at a temperature T_{bed} at a first pre-build position, where the T_{bed} is a temperature greater than the T_{feed} temperature of the powder at the first loading position.

The systems may also comprise a controller configured to effect a temperature at the upper surface of a workpiece disposed on the build platform. This may be accomplished, as described, by a laser or other modality. As described elsewhere herein, this temperature may be an elevated one, e.g., a temperature greater than the melting transition temperature of the material of the upper surface of the workpiece.

Aspect 12. A method, comprising: transporting a first amount of feed polymer (which feed polymer may be, e.g., in powder form or in particulate form) at a temperature T_{feed} from a first loading position and depositing at least a portion of the first amount of feed polymer on a print area;

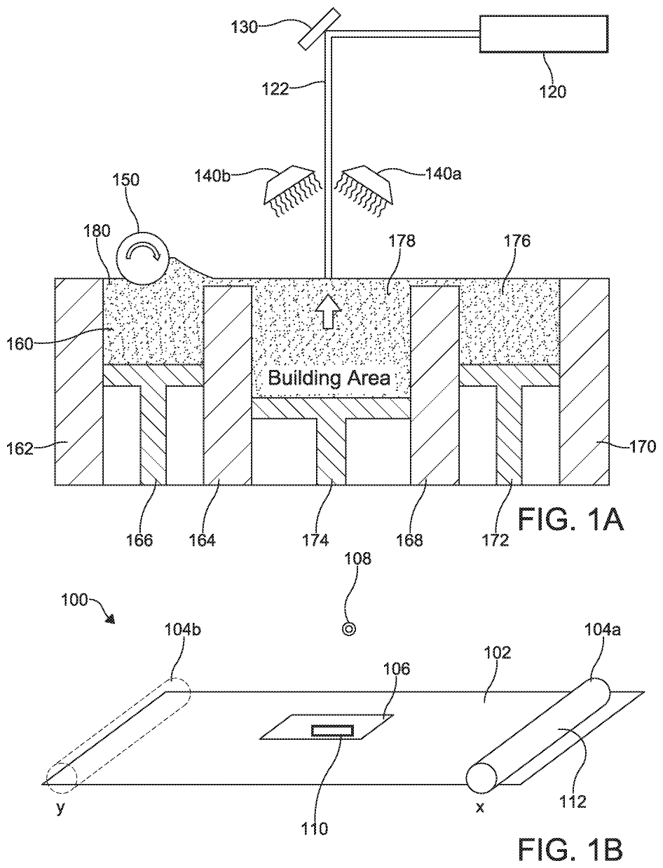

increasing the temperature of the portion of the first amount of feed polymer deposited on the print area to a temperature T_{bed} (with a heat source such as but not limited to one or more infrared heaters, see 140a and 140b in FIG. 1A) which temperature is greater than T_{feed};

irradiating at least a portion of (based on the pattern to be printed) the first amount of feed polymer deposited on the print area with a laser so as to increase the temperature of the portion of the first amount of feed polymer to a temperature Tᵢ that is greater than Tbed, resulting in full melting and coalescence of the portion of the first amount of feed polymer and formation of a printed layer of a workpiece;

transporting a second amount of feed polymer (which feed polymer may be, e.g., in powder form or in particulate form) at a temperature T_{feed} from a second loading position to a first pre-build position;

reheating an upper surface of the printed layer to temperature Tᵢ with a laser (which can be the same laser as described above or another laser);

depositing at least a portion of the second amount of feed polymer onto the upper surface of the workpiece; and

heating at least the portion of the second amount of feed polymer to Tᵢ,

the heating being effected so as form a pattern of fused polymer and to effect full coalescence between the portion of the second amount of feed polymer and the upper surface of the workpiece, such that the portion of the second amount of feed polymer becomes the upper surface of the workpiece.

In some aspects, Tᵢ is selected such that the upper surface of the workpiece achieves a viscosity of less than about 10⁴ Pa·s. In aspects where the polymer comprises a crystalline or semicrystalline material, T_{bed} may be near to but not greater than the onset of the melting transition temperature for that material. In aspects where the polymer comprises an amorphous material, T_{bed} may be near (e.g., within about 5° C.) the Tg transition temperature for that material.

The disclosed technology may be applied to a variety of polymers, including amorphous and semi- or even crystalline polymers. Some suitable polymers include, e.g., polyalkylene terephthalate, a polyalkylene naphthalate, poly(phenylene oxide), polycarbonate, poly(styrene), poly(amide), a polyolefin, PEI, PEEK/PAEK, polyamides, and the like. (It should be understood that the foregoing list is exemplary only and is not limiting in any way.)

T_{feed} may be chosen such that the polymer is pre-heated without also compromising its flow/spreadability, as polymer (e.g., powder) flowability may decrease with temperature. The polymer may be kept at comparatively high temperatures so that the difference between T_{bed} and T_{feed} is relatively easily supplied by a heater (e.g., an infrared heater) so as to bring a just-spread layer (at T feed) up to the bed temperature T_{bed}.

T_{feed} may differ from T_{bed} by, e.g., 1-30, 1-40, 1-50, 1-60, 1-70, 1-80, 1-90, 1-100, 1-120, 1-140, 1-150, or even 1-200° C. (and all intermediate values), e.g., by 35, 45, 55, 65, 75, 85, 95, 110, 130, 145, 160, 170, 180, 190 or even about 200° C.

Aspect 13. The method of aspect 12, wherein increasing the temperature of the portion of the first amount of feed polymer deposited on the print area to a temperature T_{bed}, which temperature is greater than T_{feed} is effected by an infrared source, by a laser source, or both.

Aspect 14. The method of aspect 12 or 13, wherein irradiating at least a portion of the first amount of feed polymer deposited on the print area is effected by an energy source.

Aspect 15. The method of aspect 14, wherein the energy source comprises at least one laser.

Aspect 16. The method of any of aspects 12-15, wherein increasing the temperature of the portion of the first amount of feed polymer deposited on the print area to a temperature T_{bed}, and irradiating at least a portion of the first amount of feed polymer deposited on the print area so as to increase the temperature of the portion of the first amount of feed polymer to a temperature Tᵢ are effected by the same source.

Aspect 17. The method of any of any of aspects 12-16, wherein reheating an upper surface of the printed layer to temperature Tᵢ with an energy source is effected using a primer pattern that is least partially based on a first heating pattern used to direct the heating of the portion of the first amount of feed polymer so as form a pattern of fused polymer.

Aspect 18. The method of aspect 17, wherein reheating an upper surface of the printed layer to temperature Tᵢ with an energy source is effected using a primer pattern that is based at least partially on the first heating pattern and also on a second heating pattern used to direct the heating of the portion of the second amount of feed polymer so as form a pattern of fused polymer.

FIG. 4 provides one example of the described methods. As shown, a first layer 400 of a workpiece may include a first layer image 402, which image corresponds to the sintered features of that layer. (In the exemplary aspect in FIG. 4, first layer image 402 comprises a comb-like shape having extended fingers.) A second layer 406 may be disposed above the first layer 400, with the second layer 406 having a second layer image 404, which image corresponds to the sintered features of that layer.

In some aspects, the first layer 400 is disposed on the build platform and a laser or other modality is used to form first layer image 402 by sintering polymer of that first layer. The system may then heat a region of first layer 400 according to a pattern (now shown) that is a combination of first layer image 402 and second layer image 404. Without being bound to any particular theory, it is believed that such an approach may assist in maintaining the detailed shapes of the sintered regions in successive layers.

At a general level, one may apply a laser to sinter powder in a shape S₀ in a first layer of powder. Following formation of shape S₀, one may then heat (to a molten or near-molten state) a shape S₁ in the first layer, where S₁ expands beyond S₀. Following that heating, a further layer is applied atop the first layer, and the expanded heated region S₁ allows for enhanced bonding between the features of S₀ and the further layer.

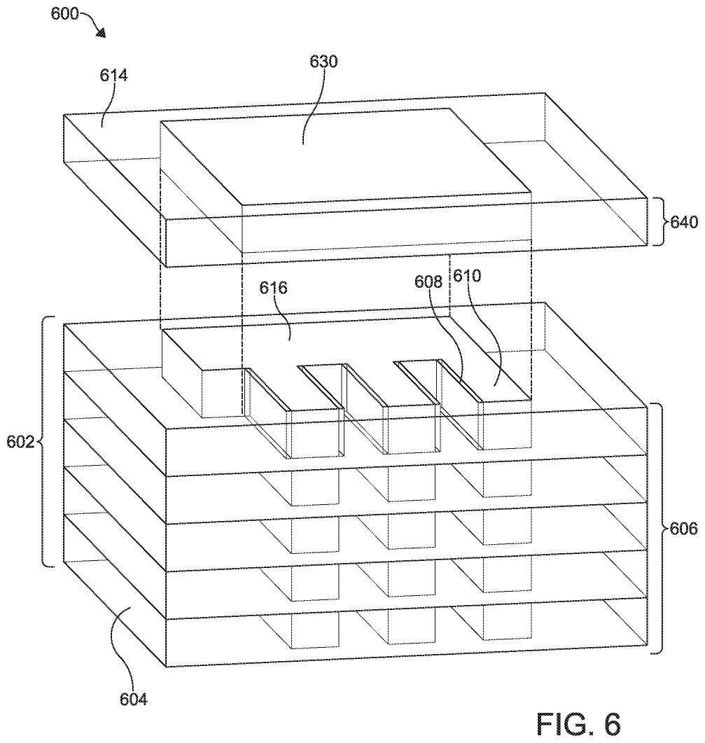

FIG. 6 provides a depiction of an alternative mode of operation. As shown in that FIG., a system may operate in a way such that when a part includes a layer having comparatively fine features, the so-called secondary heating of the top surface of that layer is done in such a fashion that the area of the top surface that is subject to secondary heating is an area that extends at least partially beyond the edge of the fine features so as to enhance bonding to the next part layer. This may be described as a combination of the two layers, i.e., the features of the reheated (secondarily-heated) region may be somewhere between the features of the next layer and the features of the current layer. For example, reheat_region=0.1*next_layer_image+0.9*current_layer_image.

As one non-limiting example, if a first layer includes a finger-like feature that has a length of 5 centimeters (cm) and a second layer includes a finger-like feature that has a length of 6 cm, the reheat region of the first layer may include a finger-like feature that has a length of 5.8 cm. As another non-limiting example, if a first layer includes a finger-like feature that has a length of 6 cm and a second layer includes a finger-like feature that has a length of 5 cm, the reheat region of the first layer may include a finger-like feature that has a length of 5.5 cm.

FIG. 6 provides a depiction of this approach. As shown in that FIG., an in-progress workpiece 600 has previously-formed layers 606, which layers sit atop build area platform. By reference to the next-to-top layer, that next-to-top layer includes a build region that comprises fused polymer (e.g., powder); in this case, the build region is E-shaped. The next-to-top region may include a build region 616, which build region may have traced-out thereon fine features 610; such fine features may be finger-like in configuration. The tracing may be done by lasing a powder, as described elsewhere herein.

When the build region of the next-to-top layer is heated in preparation for the next layer 640 to be coated on top thereof, the heating may be performed so as heat a region 608 that extends beyond the border of the fine features. In this way, the system effects enhanced bonding between the features of a first layer and the layer that is placed atop that first layer.

By further reference to FIG. 6, the next layer 640 is disposed atop the next-to-top layer. The next layer 640 may include a region 614 of polymer (e.g., powder) that is not heated, and also a region 630 of polymer (e.g., powder) that is heated; as shown in in FIG. 6, the heated region 630 may, of course, be different in shape from build region 616 in the layer below. Further (and as shown in FIG. 6), the heated region 614 of next layer 640 may align with the build region 616 of the next-to-top layer. As further shown, the heated region 608 of the next-to-top layer extends somewhat beyond the features of the build region 616, thus presenting a comparatively expanded molten region for bonding to the relevant regions of a subsequent layer.

Aspect 19. An additive manufacturing system, comprising: a dispenser configured to dispense an amount of molten polymer filament onto a polymer workpiece;

a build platform adapted to support a workpiece, one or both of the dispenser and build platform being capable of motion relative to the other; and

an energy source configured to heat an upper surface of a workpiece disposed on the build platform.

Aspect 20. The system of aspect 19, wherein the energy source is configured to heat an upper surface of the workpiece to a temperature that is within about 5° C. of Tᵢ of the upper surface of the polymer workpiece.

Aspect 21. The system of aspect 19 or 20, wherein the energy source is at least one laser.

Aspect 22. A additive manufacturing system, comprising:

a dispenser head (which may be configured to dispense particulate, filament, pellets, and the like);

a build platform adapted to support a workpiece, one or both of the dispenser and build platform being capable of motion relative to the other; and

an energy source configured to heat an upper surface of a workpiece disposed on the build platform.

### EXEMPLARY ASPECTS

FIG. 1A depicts a representative additive manufacturing system. As shown, a laser source 120 emits radiation 122 that is directed by optics 130 (e.g., a mirror) toward building area powder 178 located at the building area. The building area powder may be advanced upward or downward by build area platform 174. Building area platform 174 may move vertically so as to define a volume that accepts powder 180 that is delivered by roller 150. (The volume may have a height defined by the motion of the building area, which may be an increment of 100 micrometers or other suitable distance so as to define the thickness of the layer of powder that is delivered by the roller onto the building area.)

Roller 150 may move build powder 180 from a first powder source area defined between walls 162 and 164; walls 162 and 164 may in fact be a single circular wall that defines a cylindrical volume. A platform 166 may move powder 160 upward such that some of powder 160 advances to the position of build powder 180, where the build powder 180 is moved by roller 150 to the building area such that build powder 180 becomes powder 178.

A second powder source area may be defined by walls 168 and 170; walls 168 and 170 may in fact be a single, circular wall that defines a cylindrical volume. Platform 166 may move powder 176 upward such that powder 176 may be accessed and swept by roller 150 (not shown), when roller 150 is in position to access powder of the second powder source area.

The system may also be configured to sweep aside powder that lies above the surface of the substrate (e.g., wall 164 or wall 168) in which the building area is disposed, i.e., similar to leveling a cup of ingredients when baking a cake.

One or more infrared heaters (140a, 140b) may heat the spread powder to the bed temperature. The process then repeats as a laser melts and fuses each successive layer to the previous layer (according to a preset pattern) until the entire part is completed.

The operation of the standard system may be described by reference to FIG. 1B. As shown in that FIG., a system 100 may include a roller 112 that begins at loading position 104a at position X. The roller 112 may move from loading position 104a and sweep particulate powder (not shown) from position X to build platform 106. Build platform 106 may include a workpiece 110, which workpiece is under construction.

After the roller 112 delivers a first portion of particulate atop the workpiece 110, heating system 108 effects sintering of the first portion of particulate so as to give rise to a layer having the desired features, which layer then becomes the upper surface of workpiece 110. The roller may then move to loading position 104b at position Y. The roller may then convey a new portion of particulate powder from position Y to the upper surface of the workpiece 110. The heating system 108 then effects sintering of the new portion of particulate powder so as to give rise to a layer having the desired features, which layer then becomes the upper surface of workpiece 110.

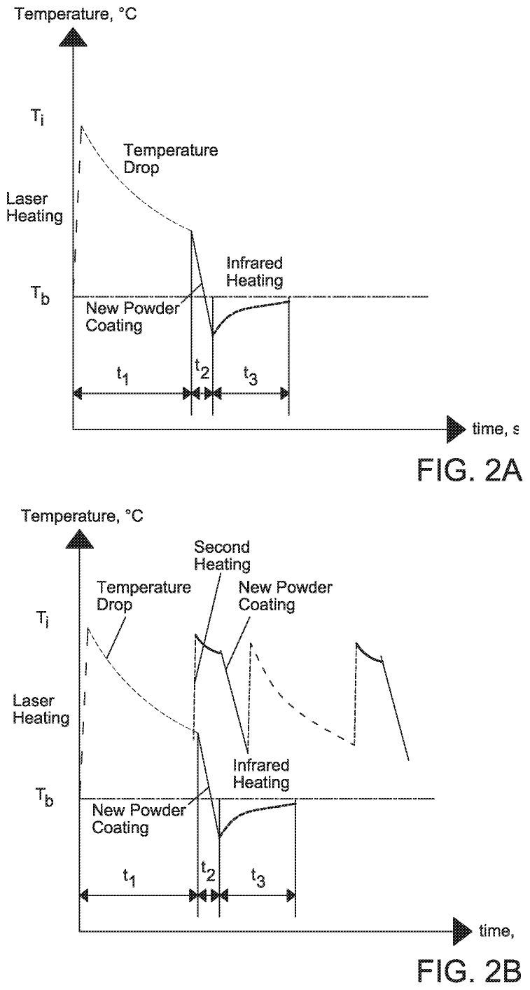

Such a cycle can be schematically plotted in terms of temperature versus time for the top layer of a workpiece, as shown in FIG. 2A. As shown, the temperature of a printed layer decreases rapidly before the next layer of powder is coated, and even decreases further (often to below the solidification temperature) when the next layer of powder is coated whose temperature is lower than the bed temperature. When the next layer of powder is coated, that next layer comes in contact with an already solidified layer. This results in a poor wetting of the powder via a weaker interaction between the previous layer and the following layer. When the following layer is then made molten by the laser, there will be a distinct interface between these successive layers. This ultimately results in a part with poor mechanical properties, in particular in the z-direction of printed parts.

By reference to FIG. 2A, it is shown that laser application raises the temperature of a powder layer to a temperature Tᵢ. Following the laser application, the temperature of that layer falls, as shown over the course of time interval t₁. Application of a new powder layer over time interval t₂ after interval t₁ then brings the temperature at the interface of the previous and new layers to a temperature that is below T_{bed}, which is the bed temperature of the system. Infrared heating may be applied to bring the temperature of the top layer of the sintered part back up to T_{bed} (bed temperature). As discussed above, however, the temperature cycle of such existing systems can lead to inferior part strength, as new powder comes into contact with a top workpiece layer that is already solidified, thus resulting in relatively poor wetting between the two layers.

FIG. 2B provides the temperature profile of an exemplary system according to the present disclosure. As shown in that FIG., time interval t₂ may begin with a so-called second heating step of the top layer of the workpiece (e.g., via laser) so as to bring the temperature of the top layer of the workpiece up to Tᵢ. Following the second heating, new powder may be coated (at the beginning of time interval t₃) onto the top layer of the top layer of the workpiece, which top layer is at a temperature greater than T_{bed} (and approaching Tᵢ), so as to be relatively molten and allow for improved wetting between the newly-added powder and the layer beneath. Repeated cycles of this approach may be used (as shown to the right of interval t₃), so as to allow for each newly-added layer of powder to be spread onto a layer beneath that is at least partially molten.

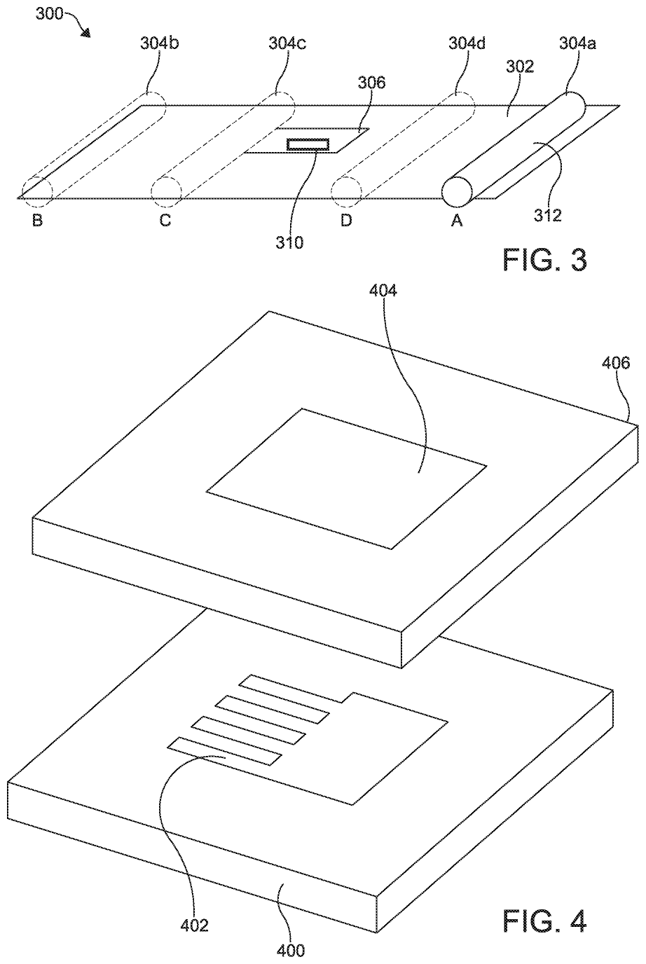

An exemplary system according to the present disclosure is provided in FIG. 3. As shown in that figure, a system 300 may include a substrate 302 and a roller (or other powder spreading instrument) 312. The roller 312 may begin at loading position A, represented by 304a.

A first layer may be printed with a conventional SLS printing protocol in which a first amount of feed polymer (e.g., powder) at T_{feed} is applied to the roller 312, which transports the first amount of feed polymer to the print area at the build platform 306, depositing at least a portion of the first amount of feed polymer at the build platform 306. In this process the roller 312 moves from position A to a second feed position B (304b). Meanwhile, the first amount of feed polymer applied to the print area is heated to T_{bed} by a heat source such as but not limited to one or more infrared heaters. Next, an energy source (such as but not limited to one or more lasers) selectively heats and melts the first layer of the part intended to be printed to temperature Tᵢ (according to the drawing file pattern).

At second feed position B (304b) the roller 312 and picks up a second amount of feed polymer (e.g., powder). The second amount of feed polymer is at a temperature T_{feed}. The roller 312 transports the second amount of feed polymer from the second feed position B (304b) to a first pre-build position C (304c), where in some aspects the roller 312 temporarily stops. The energy source is applied again to the workpiece 310 with a smaller power to compensate for the temperature drop that is caused by the time lapse between the current time and the time of the prior heating step, raising the temperature of the upper surface of the workpiece 310 back to Tᵢ. The roller then moves from position C (304c) to position D (304d) and so doing applies at least a portion of the second amount of feed polymer onto the upper surface of the workpiece 310. This newly added powder layer on the workpiece 310 is then heated to temperature T_{bed} by the heat source (e.g. infrared heater(s)) and then to temperature Tᵢ by the energy source (e.g., one or more lasers) to melt and coalesce the layer on the upper surface of the workpiece 310. Interdiffusion of polymer chains between this second layer and the upper surface of the workpiece 310, which are both in a molten state at temperature results in strong z-direction inter-layer adhesion between the layers.

This process may then be repeated to form additional layers on the workpiece 310.

As described herein, the upper surface of workpiece 310 may be heated to an elevated temperature Tᵢ. That elevated temperature Tᵢ is suitably one that allows for formation of additive parts that exhibit full coalescence between the upper surface of the workpiece and a subsequent layer that has been applied to that workpiece. In some aspects, Tᵢ is one that gives rise to material viscosity of 10⁴ Pa·s or less. Without being bound to any particular temperature, in some aspects Tᵢ is one that yields a viscosity low enough to give full coalescence. The upper surface of the workpiece 310 may be heated to Tᵢ using any suitable power source, such as one or more lasers.

It should be understood that the energy source may include a laser that is used to effect patterned sintering of a layer of powder that is applied to the upper surface of the workpiece 310. The energy source may include multiple energy sources, e.g., one laser to effect patterned sintering in the layer of powder that is applied to the upper surface of the workpiece, and another laser that is used to elevate, maintain, or elevate and maintain the temperature of the upper surface of the workpiece before powder is applied to that upper surface.

It should also be understood that the disclosed systems and methods may be operated in a batch manner, a semi-batch manner, or even in a continuous manner. As one example, a system may operate to (1) transport a first amount of feed polymer (e.g., particulate, powder) from a first loading position to an upper surface of a polymeric workpiece on the build platform; (2) heat at least a portion of the first amount of feed polymer on the workpiece to an elevated temperature T_{bed}; (3) heat the upper surface of the workpiece to a temperature Tᵢ to form a printed layer of the workpiece (described elsewhere herein); (4) transport a second amount of feed polymer from a second loading position to a first pre-build position; (5) re-heat the upper surface of the workpiece to temperature Tᵢ; (6) deposit at least a portion of the second amount of feed polymer onto the upper surface of the workpiece; and (7) heat and/or sinter the portion of the second amount of feed polymer on the workpiece to T_{bed} and then Tᵢ so as to form a sintered pattern of polymer on the layer and to sinter at least a portion of the layer to the workpiece. One or more of the foregoing steps may be accomplished in a stepwise fashion, e.g., transporting the second amount of feed polymer from the second loading position to the first pre-build position, pausing, and then heating the upper surface of the workpiece to temperature Tᵢ before at least a portion of the second amount of feed polymer is deposited onto the upper surface of the workpiece.

Alternatively, one or more of the foregoing steps may be accomplished in a continuous fashion, e.g., whereby the second amount of feed polymer is transported from the second loading position to the first pre-build position and in a continuous fashion the upper surface of the workpiece is re-heated to temperature Tᵢ before at least a portion of the second amount of feed polymer is deposited onto the upper surface of the workpiece

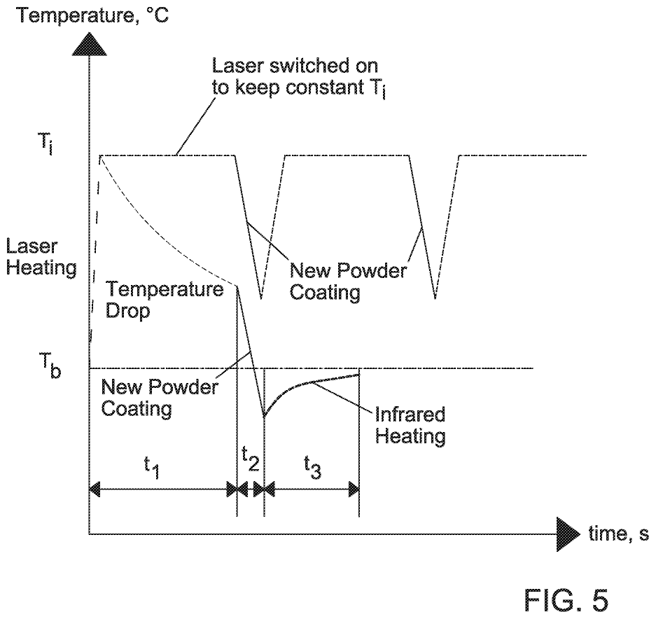

FIG. 5 provides a further alternative aspect of the disclosed technology. As shown in that FIG., a system may be equipped with more than one energy source (e.g., one or more lasers) or, alternatively, the system may be switched on and off regardless of roller position. (By reference to FIG. 3, laser-effected secondary heating may be performed without roller 312 having to stop at positions C and D.)

More specifically, a laser may be left on such that the temperature of the top layer of the workpiece molten and maintained at temperature Tᵢ until or just before coating the next layer. As discussed above, in a standard printing routine, the temperature of the molten part drops from Tᵢ because the laser is switched off and there is no constant heat supply to maintain the temperature at Tᵢ. As a result there is (in the standard printing routine) a heat transfer from the high temperature area (molten part) to the surrounding environment that is at a comparatively lower temperature.

As shown in FIG. 5, however, a laser may be left “on” so as to heat the top layer of the workpiece such that the top layer is maintained at a temperature Tᵢ (and/or at or nearly at a molten state), with the laser heating being interrupted only when new powder is coated onto the top layer of the workpiece. In this case the heat supply from the laser is interrupted only during coating, e.g., when roller 312 in FIG. 3 moves between positions C and D. In this way, a system may maintain the top layer of the workpiece at a comparatively high temperature (e.g., Tᵢ or other molten temperature) for as great a time as possible, thus maximizing the wetting of the next-added layer of powder as that next-added layer contacts the top layer of the workpiece, thus enhancing inter-layer adhesion as successive layers are added.

Exemplary Results

Without being bound to any particular theory, one cause of the insufficient interlayer adhesion seen in existing additive manufacturing approaches lies in the fact that in some cases, users are dealing with amorphous materials that only have Tg and require significant energy to melt and reach viscosities in the range of <10⁴ Pa·s so as to enable good particle coalescence and full densification of the layer. The Tg on the other hand, limits the powder bed temperature in the SLS machine, as above this temperature, the powder starts to soften and becomes sticky, thereby impeding powder flow and with that the overall sintering process.

A problem, however, arises in the adhesion between the layers. Because there is a time elapsed between building successive layers, a temperature gradient exists across interfaces. Consequently the bonding between layers becomes weaker. To approximate (or even achieve) having a molten layer over a molten layer so as to give enough mobility to polymer chains to interconnect and provide good connection between the layers, the present method describes using a laser to perform sintering and heating and also adjusting the position of the roller to shorten the time between the sintering step and the deposition of the next powder layer.

Table 1 below demonstrates the clear improvement in flexural performance of exemplary 3D printed samples in the z-direction by using a double function laser to provide additional heating to compensate for temperature drops.

TABLE 1
Results from a reference sample (0) and addition of additional heating step:
1 × 10 W, 1 × 20 W, 1 × 30 W (single heating step of 10, 20
and 30 W laser power) and 2 × 15 W, 2 × 20 W, 2 × 30 W (double
heating step with 15, 20 and 30 laser power, according to the present disclosure).
The data reported in Table 1 was collected using a polyetherimide sample (Ultem ™ CRS5011).

| Extra-heating | 0 | 1 × 10 W | 1 × 20 W | 1 × 30 W | 2 × 15 W | 2 × 20 W | 2 × 30 W |
|---|---|---|---|---|---|---|---|
| Flexural Modulus | 962 | 1022 | 1189 | 1204 | 1363 | 2085 | 2047 |
| MPa, ASTM | | | | | | | |
| Flexural Stress | 4.8 | 5.7 | 7.4 | 9 | 10.7 | 22.1 | 33 |
| MPa, ASTM | | | | | | | |
| Density | 94% | 95% | 94% | 94% | 94% | 94% | 94% |

| | Without modified | With modified |
|---|---|---|
| | protocol | heating |
| | (Standard SLS | protocol |
| Property | cycle) | (optimized) |
| Tensile, MPa | — | 26.3 |
| (z-direction) | (too low to be | |
| | detected) | |
| Flexural, MPa | 4, 8 | 60.1 |
| (z-direction) | | |

As shown above, although the density did not change in the printed parts with different heating applications, the mechanical performance did as shown above. More specifically, the mechanical properties followed an increasing trend of flexural modulus and strength with more intensive heating steps.

LFAM

So-called large format additive manufacturing (LFAM) systems are also within the scope of the present disclosure, as such systems may utilize pellets of polymeric material according to the present disclosure to form parts.

In a LFAM system, a comparatively large extruder converts pellets to a molten form that are then deposited on a table. A LFAM system may comprise a frame or gantry that in turn includes a print head that is moveable in the x, y and/or z directions. (The print head may also be rotatable.) Alternately, the print head may be stationary and the part (or the part support) is moveable in the x, y and/or z axes. (The part may also be rotatable.)

A print head may have a feed material in the form of pellets and/or filament and a deposition nozzle. The feed material may be stored in a hopper (for pellets) or other suitable storage vessel nearby to the print head or supplied from a filament spool.

An LFAM apparatus may comprise a nozzle for extruding a material. The polymeric material is heated and extruded through the nozzle and directly deposited on a building surface, which surface may be a moveable (or stationary) platform or may also be previously-deposited material. A heat source may be positioned on or in connection with the nozzle to heat the material to a desired temperature and/or flow rate. The platform or bed may be heated, cooled, or left at room temperature.

In one non-limiting aspect, a nozzle may be configured to extrude molten polymeric material (from melted pellets) at about 10-100 pounds per hour (lbs/hr) through a nozzle onto a print bed. The size of a print bed may vary depending on the needs of the user and can be room-sized. As one example, a print bed may be sized at about 160×80×34 inches. A LFAM system may have one, two, or more heated zones. A LFAM system may also comprise multiple platforms and even multiple print heads, depending on the user's needs.

One exemplary LFAM method is known as big area additive manufacturing (BAAM; e.g., Cincinnati Incorporated, http://www.e-ci.com/baam/). LFAM systems may utilize filaments, pellets, or both as feed materials. Exemplary description of a BAAM process may be found in, e.g., US2015/0183159, US2015/0183138, US2015/0183164, and U.S. Pat. No. 8,951,303, all of which are incorporated herein by reference in their entireties. The disclosed compositions are also suitable for droplet-based additive manufacturing systems, e.g., the Freeformer™ system by Arburg (https://www.arburg.com/us/us/products-and-services/additive-manufacturing/).

Additive manufacturing systems may use materials in filament form as the build material. Such a system may, as described, effect relative motion between the filament (and/or molten polycarbonate) and a substrate. By applying the molten material according to a pre-set schedule of positions, the system may construct an article in a layer-by-layer fashion, as is familiar to those of ordinary skill in the art. As described elsewhere herein, the build material may also be in pellet form.

The presently disclosed technology may this be applied to LFAM processes. When a new layer of material is to be applied via LFAM process atop a preceding layer, the preceding layer may be heated to a temperature Tᵢ (as described elsewhere herein) so as to improve adhesion between the new and preceding layers.

### Additional AM Processes

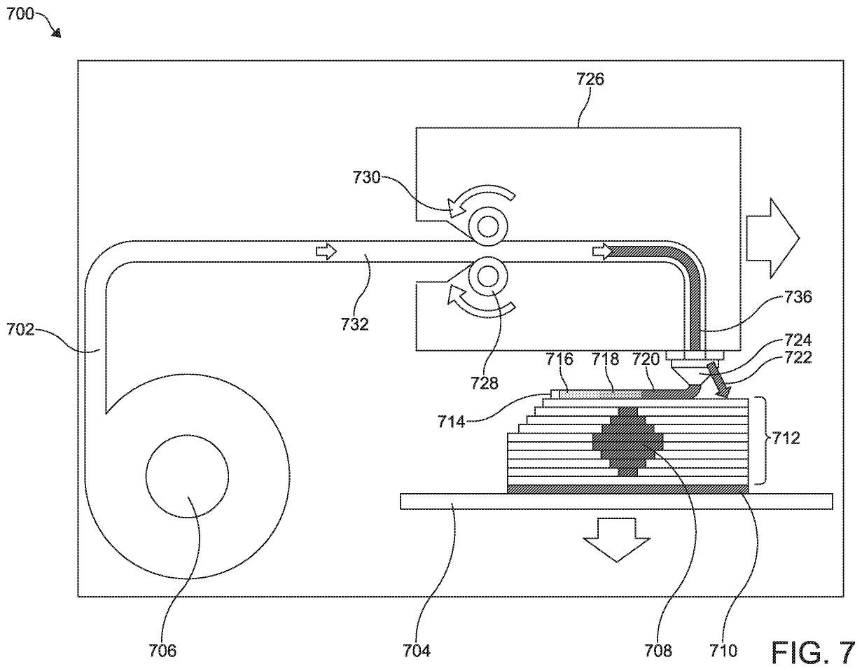

It should be understood that the presently disclosed technology may be applied to other processes besides LFAM, e.g., SLS and FFF (fused filament fabrication). An exemplary FFF process is shown in FIG. 7.

As shown in FIG. 7, a system 700 may use as a build material a filament 702. ABS is considered a suitable filament material, but other polymers may also be used as filament 702. Filament 702 may be disposed about a spool 706 or other dispenser.

Filament 702 may be fed into dispenser head 726, which dispenser head may include a channel (not labeled) through which filament 702 is fed. Drive wheels 728 and 730 may be used to pull filament 702 into dispenser head 726; as shown, there is a region 732 of filament 702 outside of dispenser head 726.

Once filament 702 enters dispenser head 726, a liquefier (e.g., a heater) acts to heat filament 702 such that a portion 736 of the filament reaches a molten, dispensable state, with the portion 736 of filament 702 being heated by the liquefier. Molten filament is dispensed out of print head 724, which may be configured as a nozzle or other suitable shape.

As shown in FIG. 7, a workpiece 712 is comprised of various previously-printed layers. The workpiece may sit atop a support 710 and may even have an internal support 708. A stage or build platform 704 may move vertically (down or up) with the application of successive layers. One or both of print head 724 and build platform 704 may be capable of motion relative to the other.

During the printing process, print head 724 dispenses an amount of filament 714. The region of the dispensed filament 714 that is farthest from print head 724 (and was printed least recently) is comparatively cool, relative to region 718 (warmer than region 716) and region 720 (warmer than region 718).

System 700 may also include a heat source 722, shown in FIG. 7 as an arrow. Heat source 722 may be a source of convective heat (e.g., a hot air gun) or radiative heat (e.g., a heating element, a laser, and the like). Heat source 722 may be configured so as to heat at least part of the upper surface of workpiece 712, e.g., to place that affected part of the surface into a molten or near-molten state. By dispensing molten filament 702 from print head 724 onto the heated upper surface of workpiece 712, one may achieve improved interlayer adhesion between the dispensed filament 714 and the uppermost surface of workpiece 712.

It should be understood that heat source 722 may be incorporated into or nearby to print head 724. In some aspects, heat source 722 may be a separate module disposed at a distance from print head 724. Heat source 722 may be configured to heat some or all of the upper surface of workpiece 712. In some aspects, heat source 722 may be configured to heat a region of the upper surface of workpiece 712 that is “upstream” of print head 724 such that the region of the surface where new material will be added is pre-heated in advance of the application of dispensed material.

1. An additive manufacturing system, comprising a substrate having an upper surface;
a build platform having an upper surface;
the build platform being moveable relative to the substrate so as to alter a distance between the upper surface of the substrate and the upper surface of the build platform;
a spreader configured to transfer a quantity of particulate from at least a first loading position on the upper surface of the substrate to a first pre-build position on the upper surface of the substrate and a first pre-build energy source configured to effect a temperature at the first pre-build position that is higher than a temperature at the first loading position,
the spreader further being configured to transfer a quantity of particulate from the first pre-build position to the build platform;
and
a first build platform energy source configured to heat material disposed atop the build platform.

2. The additive manufacturing system of claim 1, wherein the first build platform energy source and the first pre-build energy source comprise a single laser.

3. The additive manufacturing system of claim 1, wherein the spreader is moveable to a second loading position and optionally moveable to a second pre-build position.

4. The additive manufacturing system of claim 3, wherein the spreader is moveable between the second pre-build position and the build platform.

5. The additive manufacturing system of claim 4, wherein the additive manufacturing system further comprises one or more controllers configured to maintain a temperature at one or more of the build platform, the first loading position, the first pre-build position, the second loading position, and the second pre-build position.

6. A method, comprising:
transporting a first amount of feed polymer at a temperature T_{feed} from a first loading position on a substrate and depositing at least a portion of the first amount of feed polymer on a print area on the substrate;
increasing the temperature of the portion of the first amount of feed polymer deposited on the print area to a temperature T_{bed}, which temperature is greater than T_{feed};
irradiating at least a portion of the first amount of feed polymer deposited on the print area so as to increase the temperature of the portion of the first amount of feed polymer to a temperature Tᵢ that is greater than T_{bed}, resulting in full melting and coalescence of the portion of the first amount of feed polymer and formation of a printed layer of a workpiece;
transporting a second amount of feed polymer at a temperature T_{feed} from a second loading position on the substrate to a first pre-build position on the substrate;
reheating an upper surface of the printed layer to temperature Tᵢ with an energy source;
depositing at least a portion of the second amount of feed polymer onto the upper surface of the workpiece; and
heating at least the portion of the second amount of feed polymer to Tᵢ,
the heating being effected so as form a pattern of fused polymer and to effect coalescence between the portion of the second amount of feed polymer and the upper surface of the workpiece, such that the portion of the second amount of feed polymer becomes the upper surface of the workpiece.

7. The method of claim 6, wherein increasing the temperature of the portion of the first amount of feed polymer deposited on the print area to a temperature T_{bed}, which temperature is greater than T_{feed} is effected by an infrared source, by a laser source, or both.

8. The method of claim 6, wherein irradiating at least a portion of the first amount of feed polymer deposited on the print area is effected by an energy source.

9. The method of claim 8, wherein the energy source comprises at least one laser.

10. The method of claim 6, wherein increasing the temperature of the portion of the first amount of feed polymer deposited on the print area to a temperature T_{bed}, and irradiating at least a portion of the first amount of feed polymer deposited on the print area so as to increase the temperature of the portion of the first amount of feed polymer to a temperature Tᵢ are effected by the same source.

11. The method of claim 6, wherein reheating an upper surface of the printed layer to temperature Tᵢ with an energy source is effected using a primer pattern that is least partially based on a first heating pattern used to direct the heating of the portion of the first amount of feed polymer so as form a pattern of fused polymer.

12. The method of claim 11, wherein reheating an upper surface of the printed layer to temperature Tᵢ with an energy source is effected using a primer pattern that is based at least partially on the first heating pattern and also on a second heating pattern used to direct the heating of the portion of the second amount of feed polymer so as form a pattern of fused polymer.

13-15. (canceled)
